(19) United States
(12) Patent Application Publication
(10) Pub. No.: US 2012/0061230 A1
(43) Pub. Date: Mar. 15, 2012

(54) SUCTION DEVICE FOR GASES OR FUMES, IN PARTICULAR WELDING FUMES, HAVING AN OXIDATION APPARATUS, WELDING SYSTEM AND ASSOCIATED METHOD

(75) Inventors: Thomas Schubert, Soest (DE); Michael Gessler, Goldbach (DE); Bernd Block, Erlangen (DE); Markus Mindt, Erlangen (DE)

(73) Assignee: ADVANCED NUCLEAR FUELS GMBH, KARLSTEIN (DE)

(21) Appl. No.: 13/255,975

(22) PCT Filed: Mar. 2, 2010
(86) PCT No.: PCT/EP2010/001280

§ 371 Date: Nov. 28, 2011

(30) Foreign Application Priority Data
Mar. 10, 2009 (DE) 10 2009 011 961.2

(51) Int. Cl. B01D 53/00

(52) U.S. Cl. 204/157.3

(57) ABSTRACT

A suction device has a suction pipe for aspirating fumes containing metal particles, in particular welding fumes, which aims to allow safe control of the fumes with a minimum of equipment expense and operational expense. For this purpose, an oxidation apparatus is provided according to the present invention. The particles flowing past the oxidation apparatus during operation are heated by way of a power supply and are thus oxidized.

The invention relates to a suction device having a suction pipe for sucking fumes or dust which contains metallic particles. It furthermore relates to a welding system comprising such a suction device and to a corresponding method for treating welding fumes or dust.

When specific metallic materials are being welded, fine dusts or fumes containing combustible metallic particles are released. The welding fumes released during the processing of zirconium, in particular, are extremely combustible and explosive. One possible way to reduce the risk of fire or explosion consists in carrying out the welding processes within an encapsulated welding chamber. There is nevertheless a risk of explosion in the dry state of the welding fumes and in the event of incorrect handling. According to the present prior art, the fumes or dust containing the combustible particles, which arise during welding within the welding chamber, are therefore conducted by means of a suction device into a water reservoir, where it is partially bound. The water reservoir generally cannot completely bind the fumes or dust, however, and therefore it is necessary to use a residual dust filter, connected downstream of the water reservoir, in which flammable material furthermore accumulates. Owing to the penetration of atmospheric oxygen which has been sucked in into the intake section or into the residual dust filter, there is still a potential risk, which can only be controlled safely to some extent by relatively laborious handling of the welding fumes in the wet or moist state.

The invention is therefore based on the object of specifying a method and an associated device which make it possible to safely control combustible welding fumes while keeping the expenditure in terms of apparatus and operation low.

According to the invention, the object relating to the device is achieved by the provision of at least one oxidation apparatus, which acts on the fumes or dust guided in the suction pipe and is selected from the following group: a microwave radiation generator, a laser, in particular a diode or YAG laser, a heating or halogen lamp, a heating coil, an induction coil, a gas flame.

The invention is based on the consideration that a threat to the environment by combustible welding fumes can be avoided by the earliest possible and most complete possible, controlled oxidation of the combustible particles, which are thereby rendered incombustible. Here, contact of the particles both with an open flame and with a hot surface should preferably be avoided, in order to avoid ignition and so as not to provide a source of risk by virtue of the oxidation apparatus itself.

On the contrary, a contactless principle of operation is advantageously provided here for the introduction of energy: an oxidation apparatus which is preferably positioned as far forward as possible in the initial region of the intake section heats the metal particles which flow past as early as possible to their oxidation temperature. The heating of the particles leads to increased, but nevertheless controlled, oxidation at the surface with the surrounding atmospheric oxygen (or else with another oxidizing agent). If the operating parameters are suitably controlled or regulated, the risk of ignition of the welding fumes is extremely low in this concept, as became apparent in the light of model rough calculations.

Here, energy can be introduced into the welding fumes particles in a contactless manner and with a relatively high degree of efficiency over a relatively short distance of their flow path in the suction pipe. Depending on the parameters which are monitored and can be set, e.g. the mass or volume flow density in the suction pipe, the flow rate and/or the proportion of air or oxygen in the welding fumes, it is possible to meter the introduction of energy and therefore also the oxidation rate accurately, reliably and particularly in line with demand.

Here, the term “suction pipe” is not to be interpreted as restrictive within the meaning of a rigid pipe. On the contrary, a flexible tube or the like can also be used, for example.

The oxidation apparatus can be formed in various ways. In particular, it is possible to use magnetrons (for generating microwave radiation) or lasers, e.g. diode lasers or YAG lasers. As an alternative or in addition, it is possible to use lamps, e.g. halogen lamps or infrared lamps, and also heating coils, induction coils or gas flames. The various forms or a plurality of similarly designed components can also be operated in a parallel connection and/or series connection. The oxidation apparatus is advantageously provided structurally in the region of the suction pipe. By way of example, depending on the configuration, it can be integrated in the suction pipe, arranged alongside it and, if appropriate, connected to the inner region thereof by an access point, or arranged around the suction pipe.

The oxidation apparatus advantageously comprises an electromagnetic radiation generator. A preferred form of radiation here is microwave radiation. On account of the wavelength range of between about 1 m and 1 mm, this radiation is suitable for the dielectric heating or for the excitation of dipole and multipole oscillations of molecules or charged particles. The microwave radiation generator here is preferably used in such a manner that the largest possible spatial region is infiltrated by the microwave radiation as homogeneously as possible. To this end, the suction pipe can be formed as a waveguide resonant in the frequency range of microwaves.

As an alternative or in combination therewith, it is possible to heat the particles using laser radiation generated by at least one laser, in particular a diode laser or YAG laser. An Nd:YAG laser, which uses a neodymium-doped YAG crystal as active medium, generates radiation in the infrared range at the wavelength 1064 nm. Diode lasers are particularly suitable as the oxidation apparatus owing to their compact construction.

In an advantageous configuration, the particles can also be heated by a halogen lamp or the like with a suitably dimensioned radiation power.

A further advantageous embodiment of the oxidation apparatus comprises an electrical heating coil (resistance heating). An electric current flowing through the heating coil heats the heating coil and thus heats the stream of particles or gas flowing in the suction pipe. The heating coil can be wound around the suction pipe. It can also be inserted into the suction pipe. If the heating coil surrounds the suction pipe, the latter preferably consists of a material which conducts the heat emitted by the heating coil into the interior of the suction pipe with as little loss as possible.

The oxidation apparatus used is preferably an induction coil to which alternating current can be applied. By virtue of an easily achievable variation in the parameters of electric current intensity, electrical voltage and frequency of the alternating current flowing through the induction coil, it is possible to transfer the energy required for oxidation to the particles. To achieve a particularly high efficiency of the eddy current induction in the welding fume particles, the induction coil advantageously has a number of wire turns which are wound around the suction pipe. Alternatively, the induction coil could also form the pipe wall itself in the appropriate pipe portion. In contrast to an arrangement which utilizes exclusively the stray fields at the edge of or outside the coil winding, virtually the entire electromagnetic field in the interior of the coil, where the achievable field strength is the greatest, is therefore effective for the transfer of energy. If the induction coil surrounds the suction pipe, the latter is advantageously produced from a material which shields or attenuates the induction fields to the smallest possible extent, e.g. from a plastic.

In an advantageous configuration of the oxidation apparatus, a gas flame can be used as an alternative or in addition to the aforementioned concepts for heating the particles. Here, the gas flame is operated in an intensity and temperature range in which heating and subsequent oxidation of the particles are ensured and explosive or uncontrolled ignition of the stream of particles is avoided at the same time.

Under certain circumstances, the proportion of oxygen present in the welding fumes sucked in is already sufficient to allow the desired oxidation of the particles to proceed in the suction pipe. However, it is advantageous for the welding processes to take place within a welding chamber which is substantially encapsulated with respect to the environment, in particular in an inert gas atmosphere with a reduced or even absent proportion of oxygen, such that the risk of explosion and fire is minimized in any case within the welding chamber. In this case, it may be necessary or at least advantageous to deliberately enrich the welding fumes or dust sucked in from the welding chamber via the suction pipe with an oxidizing agent, in particular with oxygen-containing ambient air, before said welding fumes or dust reach the oxidation apparatus. To this end, the suction pipe advantageously has one or more air inlet openings or slots, which, as seen in the direction of flow of the fumes or dust, are arranged upstream of the oxidation apparatus, such that, during operation, a quantity of ambient air suitable for the desired oxidation reaction is also sucked in in line with demand owing to the suction effect and mixed with the welding fumes before the latter reaches the heating and oxidation zone.

With reference to the welding system comprising a welding chamber and a suction device, the aforementioned object is achieved in that the suction pipe of the suction device is connected to the welding chamber.

With reference to the method, the aforementioned object is achieved in that the fumes or dust which contain the metallic particles are sucked into a suction pipe and heated therein by the supply of energy and thus oxidized in a controlled manner. Here, the fumes or dust are advantageously guided as a continuous stream through a heating and oxidation zone in the suction pipe.

The advantages achieved by the invention consist, in particular, in that preferably contactless heating brings about controlled, complete oxidation of combustible particles of fumes or dust, which render the particles nonhazardous for further handling—in any case with reference to the risk of fire or explosion. The requirements in terms of apparatus are small, as is the required space for the technical components required. It is possible to dispense with complex wet handling of the fumes or of the dust. Additional treatment times likewise do not arise. The collection of completely oxidized dust reduces the risks when handling this waste product to an absolute minimum. The system is low-maintenance. It is only necessary to clean the suction and filter system relatively rarely, and this keeps the associated machine downtimes short. The personnel or machine operators concerned with the process operations are exposed to a smaller potential risk than has been the case to date.

The depicted concept is preferably used for the treatment of welding fumes, but is not restricted thereto. By way of example, a further field of application can be the machining (drilling, turning, milling, sawing, grinding, etc.) of metal-containing workpieces. Also, the reduction of a fire risk does not necessarily have to be the focus of interest. On the contrary, a contactless and, if appropriate, flameless heating of particles of fumes and the like could also be effected in the manner described for other technical purposes. The essential requirement is therefore merely the release or the presence of particles which can be transported in a stream of carrier gas and are generally open to the principles of operation employed according to the invention, i.e. commonly particles on a metallic basis or with a metallic proportion.

An exemplary embodiment of the invention is explained in more detail on the basis of a drawing. In each case in a highly diagrammatic illustration:

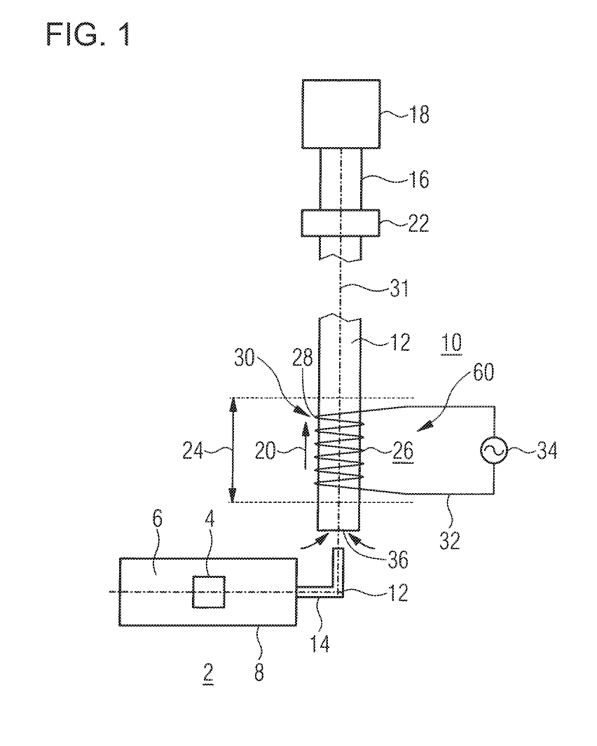

FIG. 1 shows a welding system comprising a suction device for welding fumes and comprising an induction coil as the oxidation apparatus, and

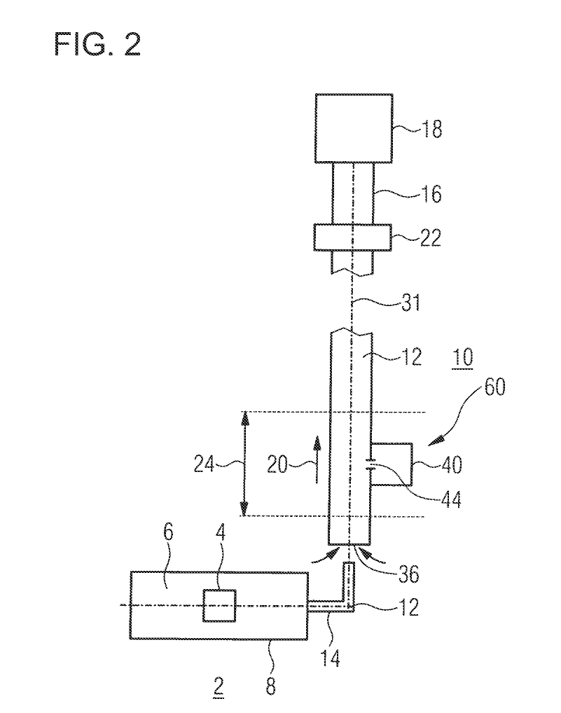

FIG. 2 shows a welding system comprising a suction device for welding fumes and comprising an alternative oxidation apparatus, e.g. a microwave radiation generator.

The welding system 2 illustrated in FIG. 1 comprises a welding appliance 4/a welding robot (not illustrated in more detail), which is arranged in the interior 6 of a welding chamber 8. Workpieces which consist of zirconium or of a zirconium alloy or contain these materials as an essential constituent are welded to one another therein, e.g. for the production of fuel rod cladding tubes in nuclear technology. The welding processes take place in an oxygen-deficient atmosphere which is rendered at least partially inert, and which is provided by supply systems not illustrated here, in the interior 6 of the welding chamber 8, which is encapsulated so as to be gastight with respect to the environment.

During welding of the workpieces, harmful dust of ultrafine zirconium particles and other particles which are easily flammable on contact with oxygen, so-called welding fumes, arise in the welding gas atmosphere. During operation of the system, the welding fumes are constantly and continuously sucked from the welding chamber 8. To this end, provision is made of a suction device 10 having a suction pipe 12. The suction pipe 12, which can also be realized as a flexible tube, for example, is connected to the welding chamber 8 at its first end 14. Alternatively, it is also possible to arrange a suction hood above a welding region which is not completely shielded from the environment by a welding chamber. The second end 16 of the suction pipe 12, which is remote from the welding chamber 8, is connected to a vacuum suction device 18 (illustrated only diagrammatically here) or a vacuum pump or a suction fan (for example in the manner of a centrifugal compressor). A gas-permeable filter unit 22 (likewise only indicated diagrammatically here) or a dust bag or the like is located upstream of the vacuum pump or upstream of the suction fan, as seen in the direction of flow 20 of the welding fumes, and solid particles which have been sucked in are retained and collected therein—depending on the pore size and the type of the filter material.

The suction device 10 is designed for a particularly low risk of fire and explosion when handling the welding fumes or the solid residues thereof in the filter unit 22. For this purpose, provision is made of a targeted and controlled oxidation of the zirconium-containing particles present in the welding fumes within a heating and oxidation zone 24 in the suction pipe 12. Specifically, in this zone, there is arranged an induction coil 26, which has a number of wire loops or wire turns 28 which are wound around the suction pipe 12. All the wire turns 28 together form the coil winding 30. The axis of symmetry of the induction coil 26 coincides with the central axis 31 of the suction pipe 12. The induction coil 26 is connected in a circuit 32 with an alternating current source 34, such that, when the circuit 32 is closed, a temporally variable, preferably periodic electromagnetic alternating field which penetrates the interior of the suction pipe 12 is generated within the coil winding 30. In the initial region and end region of the coil winding 30, the induced electrical and magnetic fields are spatially relatively inhomogeneous.

When the zirconium-containing particles flow through the heating and oxidation zone 24 in the suction pipe 12, electrical eddy currents are induced therein, resulting in heating of the particles. This promotes an intensified reaction with atmospheric oxygen present in the volumetric flow, i.e. oxidation. If the operating parameters are suitably set, the oxidation proceeds very effectively over a short distance and nevertheless in a greatly controlled manner with a low risk of fire or explosion, and therefore only relatively harmless and easily handleable, completely oxidized particles accumulate in the filter device 22.

In order to enrich the welding fumes sucked in with oxygen, the suction pipe 12 has a number of air inlet openings 36 upstream of the induction coil 26 as seen in the direction of flow 20, it being possible for these air inlet openings, for example, to have the shape of an annular slot, as is the case here in the exemplary embodiment, between two facing pipe portions or segments. It goes without saying that other inlet geometries are also possible, however.

Significant operating parameters, which are determined primarily by the flow-guiding geometry, the pressure conditions and by the (if appropriate adjustable) suction power of the vacuum suction device 18, are the flow rate of the particle-containing welding fumes within the heating and oxidation zone 24 and also the volume or mass flow density. Furthermore, the proportion of oxygen in the volumetric flow has a significant influence on the oxidation rate. The electric current intensity, the electrical voltage and the frequency of the alternating current applied to the induction coil 26 are readily controllable and, if required, adjustable, e.g. depending on the aforementioned variables, which can be monitored by suitable sensors. As an alternative or in addition, if the electrical parameters are predefined or known, it is also possible to control the supply of air or oxygen in a variable manner, e.g. by adjustable throttle flaps or the like in the air inlet openings 36.

The suction device 10 illustrated in FIG. 2 differs from the embodiment shown in FIG. 1 merely in terms of the configuration of the oxidation apparatus 60. Here, by way of example, the latter is provided in the form of a microwave radiation generator 40, which contains a magnetron. The microwave radiation generated in the magnetron is conducted through an access point 44 into the suction pipe 12 by the microwave radiation generator 40. The access point 44 between the microwave radiation generator 44 and the suction pipe 12 can be realized by a waveguide, for example. The particles flowing in the direction of flow 20 are heated by the microwave radiation in the heating and oxidation zone 24, whereupon the oxidation starts on their surface. In this embodiment, the heating and oxidation zone corresponds precisely to that region of the suction pipe 12 which is penetrated by the microwaves. In this context, the suction pipe 12 can also be understood to be a hollow body, the inner surface of which (partially) reflects the microwave radiation. In order to realize a spatial region which is as large as possible and is infiltrated as homogeneously as possible by the microwave radiation, the suction pipe 12 can be supplemented in the heating and oxidation zone 24 by components which reflect the microwave radiation. In the region of the heating and oxidation zone 24, the suction pipe can also differ in terms of its form and/or its material properties from its configuration upstream or downstream of this zone as seen in the direction of flow 20. The microwave radiation generator 40 can also be structurally integrated in the suction pipe 12.

In an alternative embodiment, the oxidation apparatus 60 illustrated diagrammatically in FIG. 2 can comprise a laser, in particular a diode or YAG laser, a halogen lamp, an electrical heating coil or a gas flame, which act on the fumes flowing in the suction pipe 12 and heat it and oxidize it in a controlled manner. A combination of a plurality of the energy and heat sources mentioned is possible.

In order to increase the oxidation efficiency, the suction pipe 12 can have a labyrinth-like structure in the form of so-called dust traps in the region of the oxidation apparatus 60, for which purpose appropriate separating and/or guide plates and/or deflecting pieces can be arranged in the pipeline, for example.

The direction of flow of the dust or fume should preferably be oriented vertically, in particular from the bottom to the top, at least in the immediate region of action of the oxidation apparatus 60.

### LIST OF REFERENCE NUMERALS

2 Welding system
4 Welding appliance
6 Interior
8 Welding chamber
10 Suction device
12 Suction pipe
14 First end
16 Second end
18 Vacuum suction device
20 Direction of flow
22 Filter unit
24 Heating and oxidation zone
26 Induction coil
28 Wire winding
30 Coil winding
31 Central axis or axis of symmetry
32 Circuit
34 Alternating current source
36 Air inlet opening
40 Microwave radiation generator
44 Access point
66 Oxidation apparatus

1-9. (canceled)

10. A method of treating welding fumes containing metallic particles, the method which comprises:
sucking the welding fumes into a suction pipe and heating the fumes in the suction pipe by supplying energy and oxidizing same; and
thereby avoiding contact of the particles with an open flame and with a hot surface.

11. The method according to claim 10, which comprising supplying the energy with at least one oxidation apparatus selected from the group consisting of a microwave radiation generator, a laser, a heating or halogen lamp, and an induction coil.

12. The method according to claim 10, which comprises supplying the energy with a diode or YAG laser.

13. The method according to claim 10, which comprises guiding the welding fumes as a continuous stream through a heating and oxidation zone in the suction pipe.

14. The method according to claim 10, which comprises, prior to heating the welding fumes, enriching the fumes with a gas or gas mixture containing an oxidizing agent.

15. The method according to claim 14, which comprises enriching the welding fumes with ambient air.

16. The method according to claim 10, wherein the welding fumes are welding fumes released during the welding of zirconium-based materials.

17. The method according to claim 10, which comprises supplying the energy via an oxidation apparatus being an induction coil, thereby applying an alternating current and generating an electromagnetic alternating field within the suction pipe, wherein the induction coil has a number of wire turns wound around the suction pipe.
